(19) United States
(12) Patent Application Publication
(10) Pub. No.: US 2004/0204057 A1
(43) Pub. Date: Oct. 14, 2004

(54) Wireless communicating device having economizing device

(76) Inventor: Leo Ku, Hsin Chuang City (TW)

Correspondence Address: Leo Ku, P.O. Box 4-67, Hsin Chuang, Taipei, 242, TW

(21) Appl. No.: 10/313,430

(22) Filed: Dec. 3, 2002

(51) Int. Cl. H04M 1/00; H04B 1/38

(52) U.S. Cl. 455/556.1; 455/574

(57) ABSTRACT

A wireless communicating device includes a wireless communicating module and one or more memories and a local network chip coupled to a CPU. The CPU includes a device for counting the non-working time of the CPU, and for stopping the CPU, and for changing the CPU to a sleeping status, and for reducing the frequency of the CPU. The CPU includes another device for check whether the CPU is in the sleeping status or not, and for recounting the non-working time of the CPU, and for restoring the CPU back from the sleeping status, and for recovering the frequency of the CPU.

### BACKGROUND OF THE INVENTION

1. Field of the Invention

The present invention relates to a wireless communicating device, and more particularly to a wireless communicating device having an electricity economizing circuit or device.

2. Description of the Prior Art

Typical telecommunicating devices, such as network system or wireless communicating devices, such as routers, frequency exchangers, local area network (LAN), wireless local area network (WLAN), etc., are normally energized all day long, or are normally situated in a stand-by status, for allowing the users to communicate with various network systems rightaway. The electric energy is thus required to be supplied to energize the the wireless communicating devices all day long, and may not be economized.

The present invention has arisen to mitigate and/or obviate the afore-described disadvantages of the conventional wireless communicating devices.

### SUMMARY OF THE INVENTION

The primary objective of the present invention is to provide a wireless or network system communicating device including an electricity economizing circuit or device for economizing the electric energy supplied to the wireless or network system communicating device.

In accordance with one aspect of the invention, there is provided a wireless communicating device comprising a CPU, a wireless communicating module coupled to the CPU, at least one memory coupled to the CPU, a local network chip coupled to the CPU, and the CPU including a unit for economizing electric energy, and another unit for recovering the wireless communicating device back to the working status.

The electric energy economizing unit includes a program for counting non-working time of the CPU, a subprogram for stabilizing a working frequency of the wireless communicating device, and a subprogram for stopping the CPU, and a subprogram for changing the CPU to a sleeping status, and a subprogram for reducing a frequency of the CPU.

The wireless communicating device recovering unit includes a program for check whether the CPU is in the sleeping status or not, and includes a program for recounting the non-working time of the CPU, and includes a subprogram for restoring the CPU back from the sleeping status, and includes a subprogram for recovering the frequency of the CPU to a working frequency.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a block diagram of a wireless communicating device in accordance with the present invention;

FIG. 2 is a block diagram illustrating an electricity economizing unit for the wireless communicating device; and

FIG. 3 is a block diagram illustrating a resetting unit for the wireless communicating device.

### DETAILED DESCRIPTION OF THE PREFERRED EMBODIMENT

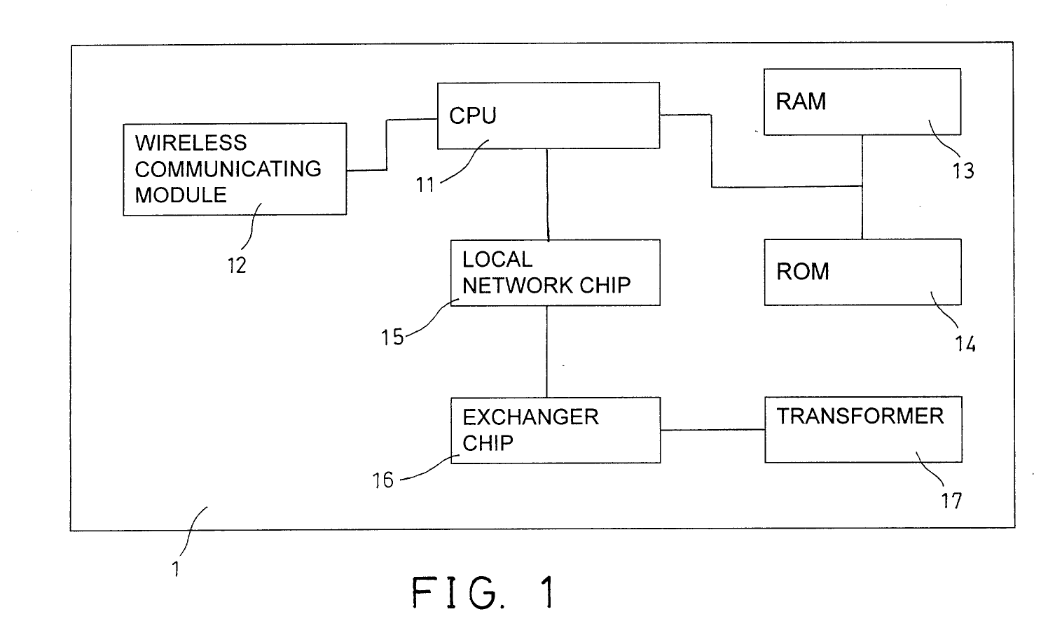

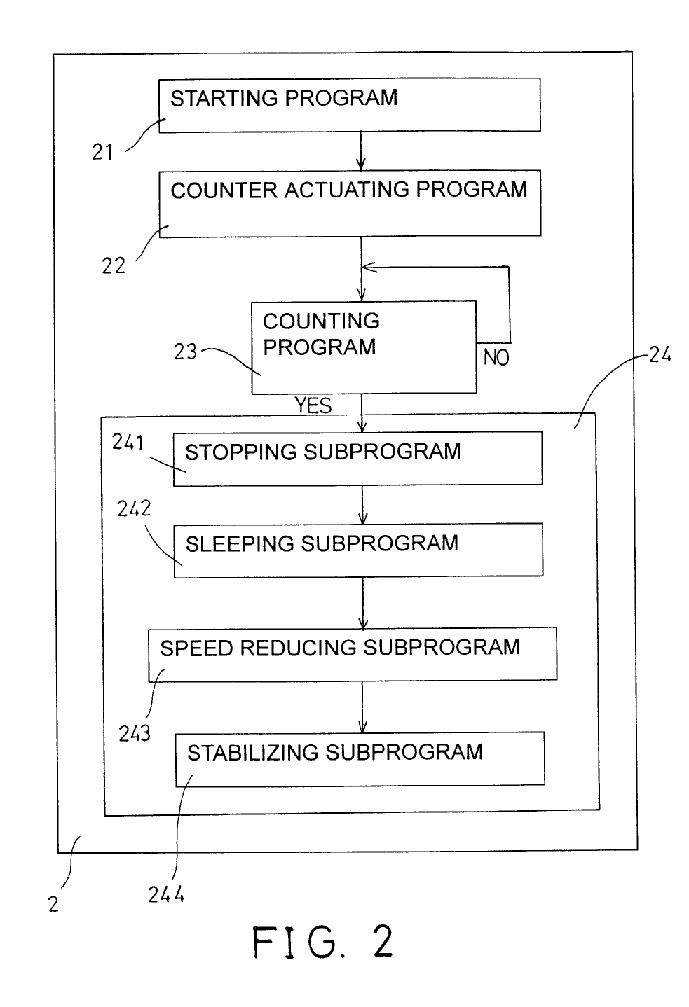

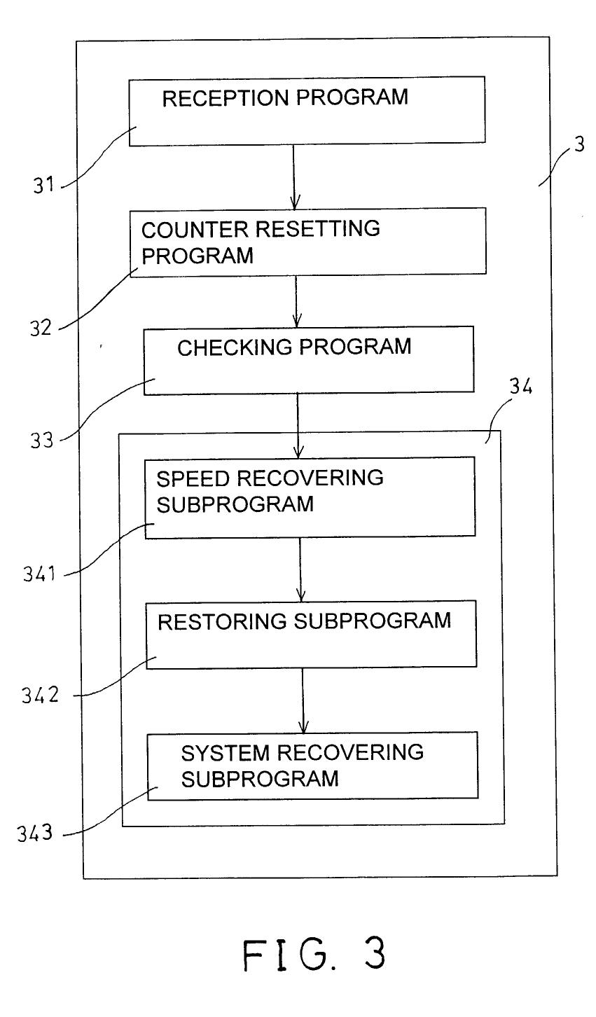

Referring to the drawings, and initially to FIG. 1, a wireless communicating device 1 in accordance with the present invention is a communicating device 1 for telecommunicating with various network systems, and comprises a central processing unit (CPU) 11 which includes an electricity economizing device or unit 2 (FIG. 2) for economizing or saving electric energy, and a resetting device or unit 3 (FIG. 3) for resetting or actuating the wireless communicating device.

The wireless communicating device 1 further includes a wireless communicating module 12 coupled to the CPU 11, a random access memory 13 and/or a read only memory 14 coupled to the CPU 11, a local network chip 15 and an exchanger chip 16 and a transformer 17 coupled to the CPU 11, for allowing the wireless communicating device 1 to communicate with various network systems.

Referring next to FIG. 2, illustrated is an electricity economizing device or unit 2 for economizing or saving electric energy for the wireless communicating device 1. The electricity economizing unit 2 includes a starting device or circuit or process or program 21 that will be energized or actuated when the wireless communicating device 1 is energized or actuated or initialized.

A counter actuating device or circuit or process or program 22 will then be energized or initialized or actuated to actuate or to start or to initialize a counting device or circuit or process or program 23, in order to detect whether the CPU 11 and/or the wireless communicating module 12 and/or the random access memory 13 and/or the read only memory 14 and/or the local network chip 15 and/or the exchanger chip 16 and/or the transformer 17 is still working or energized or not.

The counting device or circuit or process or program 23 may also calculate and count the time, such as the non-working time of the CPU 11 and/or the wireless communicating module 12 and/or the random access memory 13 and/or the read only memory 14 and/or the local network chip 15 and/or the exchanger chip 16 and/or the transformer 17 individually or separately or altogether.

The electricity economizing unit 2 further includes an electricity economizing device or circuit or process or program 24 coupled to the counting program 23, for being actuated or operated by the counting program 23.

For example, when either or some or all of the CPU 11 and the wireless communicating module 12 and the random access memory 13 and the read only memory 14 and the local network chip 15 and the exchanger chip 16 and the transformer 17 have not been energized or used or worked for a predetermined period of non-working time, such as ten minutes, twenty minutes, thirty minutes, . . . or the like, the counting program 23 may actuate the electricity economizing program 24.

Otherwise, the counting program 23 may continuously calculate or count the non-working time of the CPU 11 and the wireless communicating module 12 and the random access memory 13 and the read only memory 14 and the local network chip 15 and the exchanger chip 16 and the transformer 17.

When the electricity economizing program 24 is energized or actuated or operated or initialized, the electricity economizing program 24 includes a stopping circuit or process or subprogram 241 to stop or to terminate either or some or all of the CPU 11 and the wireless communicating module 12 and the random access memory 13 and the read only memory 14 and the local network chip 15 and the exchanger chip 16 and the transformer 17.

The electricity economizing program 24 further includes a sleeping circuit or process or subprogram 242 coupled to the stopping subprogram 231, to have either or some or all of the CPU 11 and the wireless communicating module 12 and the random access memory 13 and the read only memory 14 and the local network chip 15 and the exchanger chip 16 and the transformer 17 changed into a sleeping status, in order to safe electric energy.

The electricity economizing program 24 further includes a speed reducing circuit or process or subprogram 243 coupled to the sleeping subprogram 242, to reduce the frequency or the rate of the elements or members of the wireless communicating device 1; and further includes a stabilizing circuit or process or subprogram 244 to stabilize and to maintain the rate or the frequency of the wireless communicating device 1 within a predetermined or allowable frequency range, and for preventing the wireless communicating device 1 from being enabled or cut off.

Referring next to FIG. 3, the resetting unit 3 of the wireless communicating device 1 includes a reception or receiving program 31 for receiving signals from the CPU 11 or any other members or elements. For example, when either of the CPU 11 or the wireless communicating module 12 or the random access memory 13 or the read only memory 14 or the local network chip 15 or the exchanger chip 16 or the transformer 17 is actuated, or when any key of a keyboard (not shown) or the like is actuated, the reception program 31 may be actuated or operated by the operation of either of the CPU 11 or the wireless communicating module 12 or the random access memory 13 or the read only memory 14 or the local network chip 15 or the exchanger chip 16 or the transformer 17 or the keyboard.

The resetting unit 3 further includes a recounting or counter resetting program 32 coupled to the reception program 31 to return the counter to zero; and a checking program 33 coupled to the counter resetting program 32, to check whether either or some or all of the CPU 11 or the wireless communicating module 12 or the random access memory 13 or the read only memory 14 or the local network chip 15 or the exchanger chip 16 or the transformer 17 is actuated or is in the sleeping status or not.

The resetting unit 3 further includes a recovering program 34 coupled to the checking program 33, in order to recover the elements or members that are in the sleeping status. The recovering program 34 includes a rate or speed recovering subprogram 341 for recovering or restoring the frequency or the rate of the wireless communicating device 1; and a restoring subprogram 342 coupled to the speed recovering subprogram 341 to restore and to stabilize and to maintain the rate or the frequency of the wireless communicating device 1.

The recovering program 34 further includes a system recovering subprogram 343 for recovering the elements or members, such as either or some or all of the CPU 11 and the wireless communicating module 12 and the random access memory 13 and the read only memory 14 and the local network chip 15 and the exchanger chip 16 and the transformer 17 back to work status.

Accordingly, the wireless communicating device in accordance with the present invention includes an electricity economizing circuit or device for economizing the electric energy supplied to the wireless or network system communicating device.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A wireless communicating device comprising:
a) a CPU,
b) a wireless communicating module coupled to said CPU,
c) at least one memory coupled to said CPU,
d) a local network chip coupled to said CPU, and
e) said CPU including:
i) means for economizing electric energy, and
ii) means for recovering said wireless communicating device.

2. The wireless communicating device according to claim 1, wherein said electric energy economizing means includes means for stabilizing a working frequency of said wireless communicating device.

3. The wireless communicating device according to claim 1, wherein said electric energy economizing means includes means for stopping said CPU.

4. The wireless communicating device according to claim 1, wherein said electric energy economizing means includes means for changing said CPU to a sleeping status.

5. The wireless communicating device according to claim 4, wherein said wireless communicating device recovering means includes means for check whether said CPU is in the sleeping status or not.

6. The wireless communicating device according to claim 4, wherein said wireless communicating device recovering means includes means for restoring said CPU back from the sleeping status.

7. The wireless communicating device according to claim 1, wherein said electric energy economizing means includes means for reducing a frequency of said CPU.

8. The wireless communicating device according to claim 7, wherein said wireless communicating device recovering means includes means for recovering the frequency of said CPU to a working frequency.

9. The wireless communicating device according to claim 1, wherein said electric energy economizing means includes means for counting non-working time of said CPU.

10. The wireless communicating device according to claim 9, wherein said wireless communicating device recovering means includes means for recounting the non-working time of said CPU.
